(19) United States
(12) Patent Application Publication
(10) Pub. No.: US 2006/0133085 A1
(43) Pub. Date: Jun. 22, 2006

(54) Device for setting a spacing of a sheet from a guide during conveying through a printing technology machine

(75) Inventors: Sieghard Bendner, Bad Schonborn (DE); Andreas Detloff, Walldorf (DE); Sven Kerpe, Eggenstein-Leopoldshafen (DE); Peter Thoma, Mannheim (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/305,868

(22) Filed: Dec. 16, 2005

(30) Foreign Application Priority Data
Dec. 16, 2004 (DE) 10 2004 060 525.4

(51) Int. Cl. F21V 9/00

(52) U.S. Cl. 362/259; 362/231

(57) ABSTRACT

A device for setting a spacing of a sheet from a guide during conveying through a printing technology machine provides a simple adjusting aid when the spacing of the sheet from the guide is being set. The adjusting aid improves optical observation conditions for a machine operator. At least one optically visible light beam is directed obliquely onto the surface of the sheet. A blown air apparatus acts on the sheet and has an adjusting apparatus for blowing action of the blown air apparatus.

### BACKGROUND OF THE INVENTION

### Field of the Invention

The invention relates to a device for setting a spacing of a sheet from a guide during conveying through a printing technology machine. The device has a blown air apparatus which acts on the sheet and has an adjusting apparatus for blowing action of the blown air apparatus.

In a printing press, it is known to convey freshly printed sheets past a guide plate in such a manner as to be carried by air without contact. The height of a sheet above the guide plate can be set by the action of a blown air apparatus and/or vacuum apparatus on the sheet being changed. Typical adjusting elements are fans or blower pipes which are disposed along the conveying path individually or in groups. A large number of setting possibilities on the fans or blower pipes are available to an operator of the printing press. The operator observes the floating height of the sheet above the guide plate and sets the floating height to a desired value by changing the amount and/or direction of the blown air locally. The setting processes take a great deal of time and are imprecise, because the operator can only estimate the floating height subjectively due to unfavorable observation conditions.

In order to become independent of the experience of an operator, it is known to use control and regulating apparatuses which process signals from sensors for the floating height.

German Patent DE 197 30 042 C2 describes an apparatus for controlling sheet guidance in a sheet-fed printing press, in which the actual position of a sheet is determined with a sensor at a point of reference and compared with a setpoint position. Actuators of a blown air apparatus and/or vacuum apparatus which are directed onto a sheet are actuated as a function of the setpoint-actual value difference, with the result that the sheet end rests smoothly and completely on the circumferential surface of a cylinder while the sheet is being conveyed on the cylinder. During the control of the sheet guidance in the feeder of the sheet-fed printing press, a plurality of sensors can be directed at various points on the upper side of a sheet stack. Furthermore, rows of sensors can be used as contactless distance sensors parallel to the edges of a sheet stack.

German Published, Non-Prosecuted Patent Application DE 102 05 985 A1 shows a printing material guide element with an integrated distance sensor for sheets. When sheets are conveyed, a machine operator is shown the sensor measured values of a defined sensor or information about measured values of adjacent sensors. The machine operator can set an air flow field on the basis of the display.

German Published, Non-Prosecuted Patent Application DE 100 38 774 A1, corresponding to U.S. Pat. No. 6,889,609 and U.S. Patent Application Publication No. US 2002/0060407, has disclosed an apparatus for producing an air flow in a duplicating machine, in which ionic fans are used to support a trailing free end of a sheet that is held in grippers by a specifically set flow field, in such a way that during transport fluttering is reduced. The position of the free end of a sheet is determined with a detector and the local strength of a flow field is varied with a regulating device in such a way that the position of a desired setpoint position is approximated. Optical or ultrasound sensors which sense individual points or over a full area can be used to detect the sheet position.

In an apparatus for conveying sheets onto a stack according to German Published, Non-Prosecuted Patent Application DE 43 28 445 A1, corresponding to U.S. Pat. No. 5,582,400, a sensor is used which senses the fluttering movement of the sheets. Sensor signals are processed in a control or regulating apparatus to form adjusting signals for a blown air apparatus or vacuum apparatus.

The sensors and circuit configurations for evaluation of the sensor signals are expensive in terms of material and cost. In addition, a large number of sensors would reduce the reliability of the printing press.

### SUMMARY OF THE INVENTION

It is accordingly an object of the invention to provide a device for setting a spacing of a sheet from a guide during conveying through a printing technology machine, which overcomes the hereinafore-mentioned disadvantages of the heretofore-known devices of this general type, which provides a simple adjusting aid when setting the distance of a sheet from a guide and in which the adjusting aid improves optical observation conditions for a machine operator.

With the foregoing and other objects in view there is provided, in accordance with the invention, a device for setting a spacing of a sheet from a guide during conveying through a printing technology machine. The device comprises a blown air apparatus acting on the sheet. An adjusting apparatus adjusts blowing action of the blown air apparatus. A light source directs at least one optically visible light beam obliquely onto a surface of the sheet.

According to the invention, a light beam which can be seen well optically is directed onto the surface of a floating sheet as an adjusting aid. A machine operator can determine, even under unfavorable conditions, whether or not the sheet is at a desired floating height above the guide by using the position of the light spot on the sheet or using the number of light spots and/or using the color characteristics of the light spot.

Laser diodes providing light beams which are optionally parallelized with lenses can be used, in particular, as light sources. Two laser beams which intersect at a setpoint or desired height for a sheet are preferably used. If the actual height deviates from the setpoint height, two light spots of small diameter which are clearly separate from one another appear on the sheet. If the height of a sheet above a guide is determined at a plurality of locations with light beams, the three-dimensional position of a sheet can be monitored.

If two light beams of different color are used, in particular red and blue, the result at the intersection point of the light beams is a light spot in a mixed color, in particular green. The green light spot thus indicates the location of the desired height of the sheet above a guide. If the sheet is in front of the intersection point, two light spots with the colors red and blue appear on the surface of the sheet. If the sheet lies behind the intersection point, the red and blue light spots appear in the reversed order. An operator receives information from the color sequence of the light spots and their distance from one another as to whether and by how much the supporting air under the sheet has to be increased or reduced.

If two light beams with different cross sections are used, the result is different patterns depending on the distance of the sheets from the guide. For example, at the setpoint height, two angles which appear on the sheet can be in contact with one another exactly at the tips and, in the event of a deviation from the setpoint height, they can overlap or lie at a distance from one another.

Other features which are considered as characteristic for the invention are set forth in the appended claims.

Although the invention is illustrated and described herein as embodied in a device for setting a spacing of a sheet from a guide during conveying through a printing technology machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1 and 2 are respective diagrammatic front-elevational and plan views of a transport apparatus for sheets;

FIGS. 3.1-3.3 are plan views of a transport apparatus for sheets using different light beams; and

FIGS. 4.1-4.3 are plan views of a transport apparatus for sheets using light beams with different cross sections.

### DESCRIPTION OF THE PREFERRED EMBODIMENTS

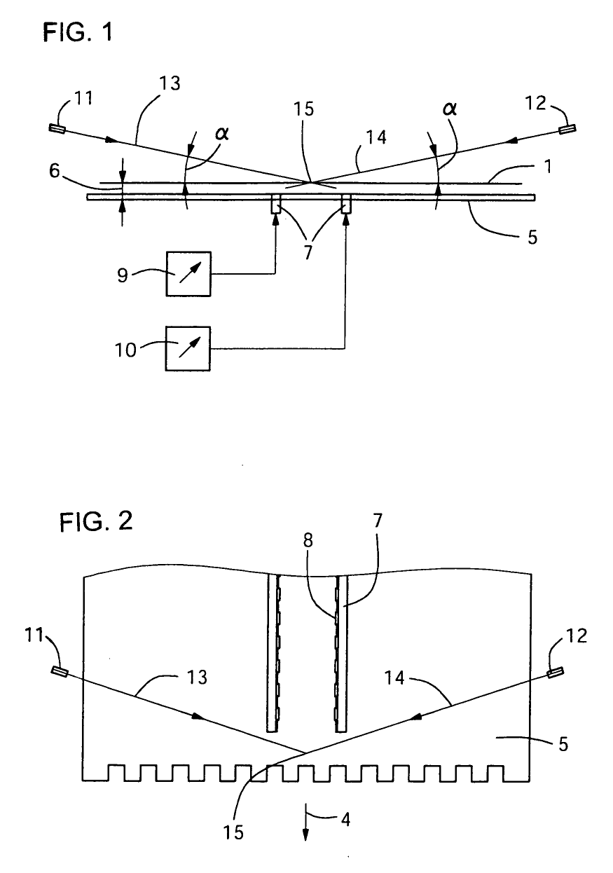

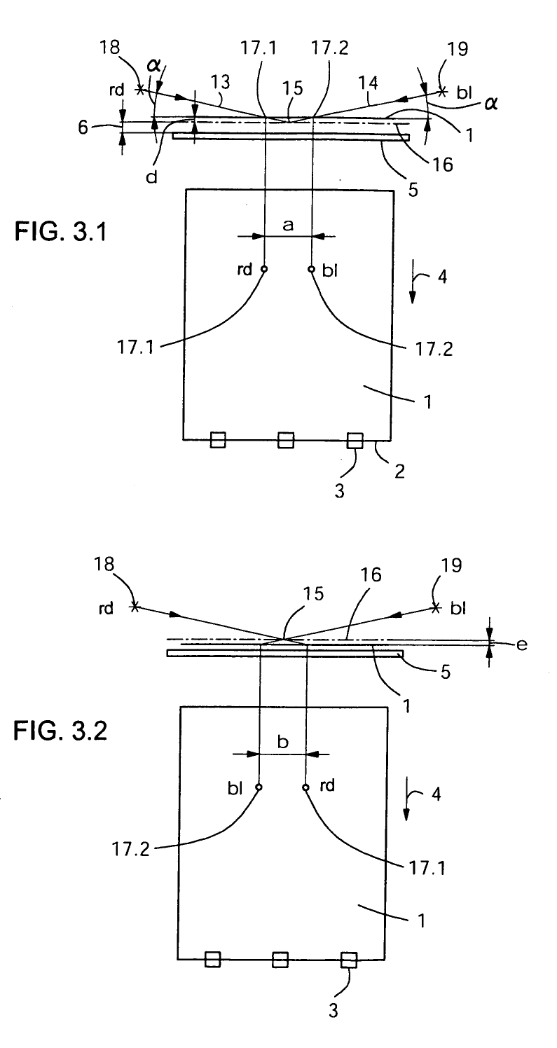

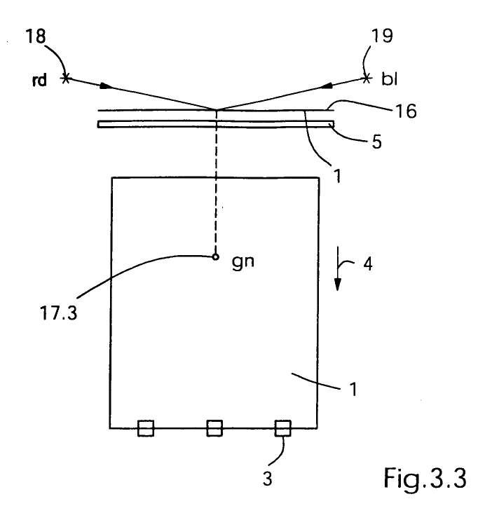

Referring now to the figures of the drawings in detail and first, particularly, to FIGS. 1 and 2 thereof, there is seen a transport apparatus for sheets 1 in a sheet-fed printing press. The sheets 1 are conveyed in a direction 4 along a guide plate 5 in such a manner that their leading edges 2 are held in grippers 3 (see FIG. 3.1). The sheets 1 float at a setpoint or desired distance 6 above the guide plate 5. Blower pipes 7 which are situated below the guide plate 5 are oriented in the direction 4 and have a multiplicity of nozzles 8 which are directed onto the underside of a sheet 1. The blower pipes 7 are connected to controllable blown air sources 9, 10. Two lasers 11, 12 are provided as adjusting aids for the distance 6 of a sheet 1 above the guide plate 5. The lasers 11, 12 are disposed laterally next to the conveying path of the sheets 1, and light beams 13, 14 of the lasers 11, 12 lie inclined at an identical angle α relative to the surface of the guide plate 5. The light beams 13, 14 meet at a point 15 in one plane 16 (see FIG. 3.1) at the setpoint distance 6 above the surface of the guide plate 5. If a sheet 1 is situated in the beam path of the lasers 11, 12, two light spots 17.1, 17.2 (or one light spot 17.3 described below and shown in FIG. 3.3) which can be seen well optically are produced on the sheet 1. The spacing between the light spots 17.1, 17.2 is a measure of the floating height of the sheet 1 above the guide plate 5.

FIGS. 3.1-3.3 illustrate the use of different color laser diodes 18, 19 of the colors red and blue, indicated by symbols rd and bl.

If, as is shown in FIG. 3.1, the blown air under the sheet 1 is set to be too strong, the sheet 1 floats above the setpoint plane 16. This results in one red light spot 17.1 and one blue light spot 17.2 on the sheet 1. The light spots 17.1, 17.2 lie along a straight line which lies transversely with respect to the transport direction 4. The light spots 17.1, 17.2 are at a spacing a which is directly proportional to the deviation of the floating height of the sheet 1 from the setpoint plane 16.

FIG. 3.2 shows the case in which the effect of the blown air on the sheet 1 is too small. The sheet 1 floats at a height below the setpoint plane 16. A red light spot 17.1 and a blue light spot 17.2 appear on the sheet 1. The light spots 17.1, 17.2 are at a spacing b from one another and, as viewed in the direction 4, lie on opposite sides as compared with the configuration according to FIG. 3.1. The spacing b is proportional to a distance e of the sheet 1 from the setpoint plane 16.

If the cases shown in FIGS. 3.1 and 3.2 occur, an operator of the printing press can deduce from the sequence of the red and blue light spots 17.1, 17.2 in the lateral direction whether the blown air has to be reduced or increased. The operator actuates an actuating element on the blown air sources 9, 10, with the result that the sheet 1 floats above the guide plate 5 in the setpoint plane 16, as is shown in FIG. 3.3. If a sheet 1 has reached the setpoint distance 6 above the guide plate 5, only one light spot 17.3 appears on the sheet. The light spot 17.3 is green in color, as is indicated by the symbol gn, which results from a mixture of the colors red and blue.

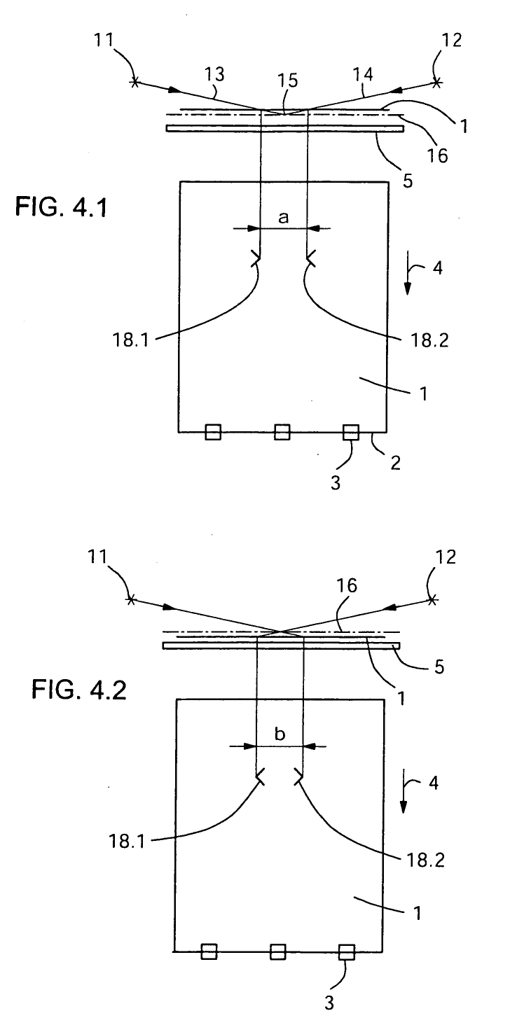

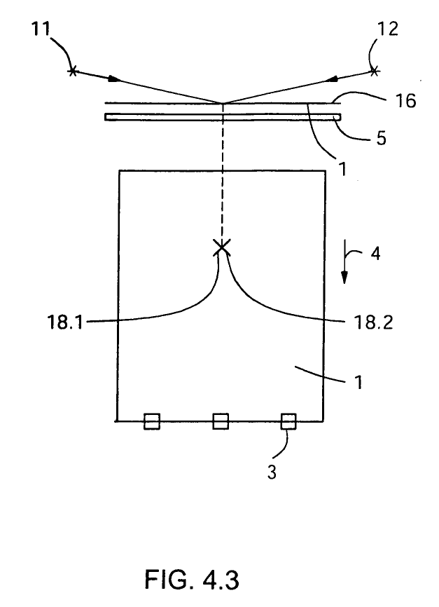

FIG. 4.1-4.3 show the use of light beams 13, 14 with different cross sections in the form of equal-length right-angled marks 18.1, 18.2.

According to FIG. 4.1, a sheet 1 floats above the setpoint plane 16. Two right-angled marks 18.1, 18.2 which appear on the sheet 1 lie symmetrically with respect to a straight line that points in the transport direction 4 of the sheets 1 and includes the intersection point 15 of the light beams 13, 14. The points of the right-angled marks 18.1, 18.2 point toward one another, from which an operator can deduce that the sheet 1 is floating too high. If the sheet 1 is floating too low, the points of the right-angled marks 18.1, 18.2 point away from one another, as is shown in FIG. 4.2. The spacings a, b between the points of the right-angled marks 18.1, 18.2 are proportional to the spacing of the sheet 1 from the setpoint plane 16. The blown air sources 9, 10 are adjusted until the points touch on the sheet 1, as is shown in FIG. 4.3. In this case, the sheet 1 is floating in the setpoint plane 16.

If more than one light source pair are used which in each case intersect at a point of the setpoint plane 16, and if a blown air source 9, 10 is used which can be controlled on a time and region basis, the position of a sheet 1 with respect to the guide plate 5 can be controlled in a targeted manner. It is thus also possible to compensate for oblique positions of a sheet 1 with respect to the setpoint plane 16.

This application claims the priority, under 35 U.S.C. §119, of German Patent Application 10 2004 060 525.4, filed Dec. 16, 2004; the entire disclosure of the prior application is herewith incorporated by reference.

We claim:

1. A device for setting a spacing of a sheet from a guide during conveying through a printing technology machine, the device comprising:
a blown air apparatus acting on the sheet;
an adjusting apparatus for blowing action of the blown air apparatus; and
a light source for directing at least one optically visible light beam obliquely onto a surface of the sheet.

2. The device according to claim 1, wherein said light source directs two light beams from different directions onto the surface of the sheet, causing the light beams to intersect at a point disposed at a desired height of the sheet above the guide.

3. The device according to claim 2, wherein the light beams have a small diameter compared to the surface of the sheet.

4. The device according to claim 2, wherein the light beams are each monochromatic and have different wavelengths.

5. The device according to claim 1, wherein said light source is at least one laser.

6. The device according to claim 1, wherein said light source directs two light beams with different cross-sectional shapes from different directions onto the surface of the sheet and forms a predefined pattern on the surface of the sheet in accordance with said cross-sectional shapes, at a desired height of the sheet above the guide.

7. The device according to claim 6, wherein said cross-sectional shapes are angular.
